(19) United States
(12) Patent Application Publication
(10) Pub. No.: US 2007/0150123 A1
(43) Pub. Date: Jun. 28, 2007

(54) System and method for controlling the airspeed of an aircraft

(75) Inventor: William E. Combs, Seattle, WA (US)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: The Boeing Company, Chicago, IL (US)

(21) Appl. No.: 11/296,967

(22) Filed: Dec. 8, 2005

(51) Int. Cl. G06F 7/00

(52) U.S. Cl. 701/3

(57) ABSTRACT

A system and method are provided for controlling the airspeed of an aircraft. A plurality of recommended airspeeds are initially determined based upon different objectives. The recommended airspeeds may be based upon various objectives including: (1) delivery of the aircraft to its destination within a predefined arrival window; (2) maximization of the fuel efficiency of the aircraft during the flight; and (3) reduction in the passenger's perceptibility of airspeed changes of the aircraft. Based upon the different objectives taken in view of the current flight conditions, a resulting airspeed is determined from the plurality of recommended airspeeds. As each objective may suggest a different recommended airspeed, the system and method may compromise between the various objectives based upon the current flight conditions so as to define the resulting airspeed. The resulting airspeed may then be applied to the auto-throttle of the aircraft.

### FIELD OF THE INVENTION

Embodiments of the present invention relate generally to aircraft control systems and methods, and more particularly, to systems and methods of controlling the airspeed of an aircraft based upon various objectives, such as to facilitate on-time arrival of the aircraft.

### BACKGROUND OF THE INVENTION

It is important for a commercial airline to ensure on-time arrival, i.e., arrival at or near the scheduled arrival time, of the airline's flights at the destination airports. Many problems can be caused when a flight arrives later than the scheduled arrival time. For example, a late arrival reduces the amount of time between such a late arrival and the departure of connecting flights for passengers on the late arriving flight. This reduced time may result in some passengers missing connecting flights and thus arriving late at the final destination. The reduced time may also increase the chance that luggage will be temporarily misplaced as it is transferred from the late arriving flight to connecting flights.

A late arrival may also result in other schedule disruptions cascading through the airline's system. The aircraft used for the late arriving flight may be scheduled to be used for another flight shortly after the scheduled arrival time, thereby causing a late departure of the other flight. Similarly, the airline flight crew on the late arriving flight may be scheduled to staff another flight shortly after the scheduled arrival time, thereby causing a late departure of the other flight. A late arrival may cause a greater number of aircraft to be at the destination airport than can be accommodated by the number of airport gates, thereby causing some arriving aircraft to have to wait on the tarmac for a gate to become available.

Perhaps most importantly, a late arrival may cause airline passengers to be dissatisfied with the airline because the passengers did not arrive at the final destination on time, because some passengers' luggage was lost, or because the passengers had to wait on the tarmac because a gate was not available. Repeated late arrivals may lower an airline's on-time arrival rating, which is published by the Federal Aviation Administration, thereby causing potential passengers to avoid flying on such an airline.

Late arrivals may be caused by many different factors. Weather may cause a late arrival, such as when an aircraft encounters sustained headwinds during flight or when an aircraft must alter the planned flight path to circumnavigate a large and potentially dangerous storm system. Departure of the aircraft later than the scheduled departure time may cause a late arrival. Such a late departure may be caused by late arrivals of the aircraft and/or flight crew used for the late departing flight, as discussed above, or by unplanned maintenance or repairs that must be performed prior to departure. An aircraft may arrive at the destination early or late even though the aircraft departed on-time and no weather problems were encountered if the scheduled arrival time of the aircraft is changed after the aircraft departs.

Even arriving earlier than the scheduled arrival time, which may be caused for example by unanticipated tailwinds, may require an aircraft to hold in a pattern awaiting a landing slot at the destination airport, thereby wasting expensive fuel.

A system for controlling the on-time arrival of an aircraft would typically analyze a number of variables, such as airspeed, wind speed (with a tailwind having a positive velocity and a headwind having a negative velocity), ground speed (which equals airspeed plus wind speed), distance to destination, and time to scheduled arrival. Each variable in such a system would be typically calibrated across a representative range of values (such as MPH to calibrate velocity; miles to calibrate distance; and minutes to calibrate time) in order to provide the necessary granularity for analysis.

These variables serve as the input values to the control system. One way to deal with the logic associated with the analysis of these input values is through the use of rule sets. Traditionally, these rules are in the form: [(A intersection B) implies R] or more informally [(A and B) then R]. Expressed another way, if the value of input-A is within a certain range and the value of input-B is within a certain range, then the output will be a certain value R. Even though this rule-based form enables a great deal of flexibility in the design of the system, rules in the traditional format outlined above suffer from a scalability condition known as the combinatorial problem. That is, as antecedent variables (also known as “antecedents”) representing criteria such as airspeed, ground speed or distance to destination are added to the rule configuration, the number of rules can increase exponentially.

For example, suppose that the calibrated values for airspeed, ground speed, the distance to destination and the time to scheduled arrival are segmented into just five categories. If the rule set relied on only one of these antecedent criteria, then it would likely contain five rules—one for each antecedent condition. If a second antecedent variable were added, then the rule set could contain as many as twenty-five rules since each one of the original antecedent conditions would now have five additional sub-conditions to be represented by rules. Adding a third criteria would increase the potential rule set to one hundred and twenty-five rules. And adding a fourth and fifth antecedent would increase the potential rule set to six hundred and twenty-five and three thousand one hundred and twenty-five rules, respectively, thereby demonstrating the combinatorial problem that as antecedent criteria are added, the number of rules tend to increase exponentially.

To combat this problem, rules that are deemed by the system designer as unimportant, duplicate or improbable are pruned from the rule set to expedite performance. Unfortunately, this tactic leaves gaps in the rule set domain and the system can enter an anomalous state if the input conditions call for a rule to be executed that was pruned.

One way to keep the system from entering into one of these gaps is to create additional rules to fence the system out of these areas. Unfortunately, the boundary conditions for these fenced areas can also grow exponentially as more rules are pruned from the system, adding their own complexity and performance degradation.

Another issue with the traditional rule configuration for control systems is the ever-increasing inability of a system designer to accurately define the output value or condition for each individual rule. This difficulty is especially acute-as the number of antecedent variables increase.

Still another issue with the traditional rule configuration for control systems is fault tolerance. If a sensor malfunctions or fails that is feeding one of the antecedents, such as by producing a value at or near zero, that value will severely impact the values of the remaining antecedents because they are linked through intersection. That is, intersection operations tend to treat the lowest input value as an upper limit for the intersection value. So, if an input sensor delivers a value at or near zero to the intersection operation, the output of that operation to the implication relation with the consequent will most likely be a value at or near zero. Instead of degrading gracefully when a sensor fails, a system based on this methodology tends to do just the opposite and degrade rapidly in the face of any sensor failure.

With all of these constraints outlined above, it might seem that employing rules to govern the control behavior of an on-time arrival system would not be feasible since many antecedent variables would be necessary to define a real-world system.

In addition to these constraints, the architecture of an on-time arrival system is also complicated by its requirement to be able to manage multi-objective control perspectives, particularly when these perspectives might conflict or even contradict each other.

For example, in one embodiment of this system, three somewhat competing perspectives might be: (1) to deliver the aircraft to its destination as closely as possible within the acceptable arrival window, regardless of the length of the flight; (2) to maximize fuel efficiency of the aircraft during the flight; and (3) to make sure that any airspeed changes that are required to ensure on-time arrival are as imperceptible to the passengers as possible. It is not hard to imagine scenarios in which these three objectives could conflict with each other. Yet the architecture must be able to provide a robust reconciliation even in circumstances where the perspectives seem to contradict one another.

The robustness of a control system is also an important consideration and depends upon both coupling and cohesion. Coupling is the strength of the relationships between modules. Cohesion is the strength of the relationships among the components of one module. System robustness is improved whenever coupling can be reduced and cohesion increased. For the traditional rule configuration, the antecedents do not have independent implication relations with the consequent, so cohesion is low. And since the input value of each antecedent must intersect with the other input antecedent values in order to produce a resultant intersection value for the implication relation with the consequent, coupling is high. Accordingly, a control system, that uses the traditional rule configuration, may not be as robust as desired.

### BRIEF SUMMARY OF THE INVENTION

A system and method are therefore provided for controlling the airspeed of an aircraft, such as to facilitate an on-time arrival. As a result of its design, certain embodiments of the system and method of the present invention may utilize an architecture that enables the development of scalable rule sets and also enables the robust management of multi-objective control perspectives even when these objectives are conflicting or contradict each other, thereby addressing at least some of the issues identified above.

In one aspect of the present invention, a method of controlling the airspeed of an aircraft determines a plurality of recommended airspeeds based upon different objectives. In one embodiment, for example, the method determines first and second recommended airspeeds based upon first and second objectives, respectively. According to this method, the second recommended airspeed is independent of the first recommended airspeed and the second objective is different from the first objective. Based upon the different objectives taken in view of the current flight conditions, the method of this embodiment then determines a resulting airspeed from the plurality of recommended airspeeds. As each objective may suggest a different recommended airspeed, the method may compromise between the various objectives based upon the current flight conditions so as to define the resulting airspeed. In effectuating this compromise between the various objectives in the determination of the resulting airspeed, the method may also weight each recommended airspeed. The resulting airspeed may then be applied to the auto-throttle of the aircraft.

In another aspect of the present invention, an aircraft is provided that includes a system for controlling the airspeed of the aircraft. The system includes a computing device for determining a plurality of recommended airspeeds based upon different objectives, such as by determining first and second recommended airspeeds based upon first and second objectives, respectively. Advantageously, each recommended airspeed is independent of the other recommended airspeed(s) and each objective is different from the other objective(s). Based upon the different objectives taken in view of the current flight conditions, the computing device is also capable of determining a resulting airspeed from the plurality of recommended airspeeds. As each objective may suggest a different recommended airspeed, the computing device may effectively compromise between the various objectives based upon the current flight conditions so as to define the resulting airspeed. In effectuating this compromise, the computing device may also weight each recommended airspeed. According to this aspect of the present invention, the aircraft may also include an auto-throttle to which the computing device applies the resulting airspeed.

The method and system may determine the recommended airspeeds based upon various objectives. In this regard, exemplary objectives include: (1) delivery of the aircraft to its destination within a predefined arrival window; (2) maximization of the fuel efficiency of the aircraft during the flight; and (3) reduction in the passenger's perceptibility of airspeed changes of the aircraft.

### BRIEF DESCRIPTION OF THE SEVERAL VIEWS OF THE DRAWING(S)

Having provided a brief summary of the invention, reference will now be made to the accompanying drawings, which are not necessarily drawn to scale, and wherein:

FIG. 1 is a block diagram of a system of one embodiment of the present invention;

FIG. 2 is a high-level flowchart of the operation of a system and method according to one embodiment of the present invention; and

FIGS. 3-5 are flowcharts of the operations associated with determining a recommended airspeed according to each of three different objectives, according to one embodiment of the present invention.

### DETAILED DESCRIPTION OF THE INVENTION

The present invention now will be described more fully hereinafter with reference to the accompanying drawings, in which some, but not all embodiments of the inventions are shown. Indeed, these inventions may be embodied in many different forms and should not be construed as limited to the embodiments set forth herein. Rather, these embodiments are provided so that this disclosure will satisfy applicable legal requirements. Like numbers refer to like elements throughout.

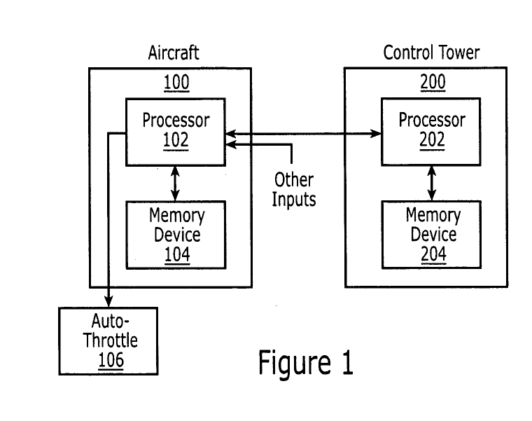

A system and method are provided according to various embodiments of the present invention for controlling the airspeed of an aircraft, such as to facilitate the on-time arrival of the aircraft. Embodiments of the present invention could be implemented as a computing device operating under control of software (or some combination of software and hardware) to provide input or otherwise control the auto-throttle (i.e., the portion of the aircraft's auto-pilot that controls the speed of the aircraft). As shown in FIG. 1, the computing device 100 may be embodied by a processor 102, such as the flight management computer of the aircraft or the processor(s) implementing the auto-throttle itself, and a memory device 104 in communication therewith for storing the software that implements the functionality of the present invention upon execution. Additionally, a computing device 100 onboard the aircraft may operate in collaboration with a computing device 200, including a processor 202 and an associated memory device 204, in the control tower of the destination airport such that the combination of the computing devices onboard the aircraft and in the control tower embody the system and method. In this embodiment in which at least a portion of the computing device is located in the airport control tower, additional criteria related to the control tower but unrelated to a particular flight, such as modifying the arrival times for in-coming aircraft in order to avoid temporary local inclement weather or to allow for an emergency landing situation at the airport, may be incorporated into the aircraft's arrival decisions to the benefit of both the aircraft and the destination airport. For the sake of illustration, FIG. 1 depicts the system of one embodiment to include a computing device 100, such as the flight management computer or other a processor onboard an aircraft, that communicates with a memory device 104, that may receive input not only from the control tower but also from sources such as the flight instruments, the flight computer and the flight crew, and that provides output, such as control signals, to the auto-throttle 106.

In general terms, the system and method of one embodiment would receive a plurality of inputs that may affect the arrival time of the aircraft, and then analyze those inputs using rule sets that will be described below to determine the recommended airspeed to be output to the auto-throttle of the aircraft. As such, the system and method of this embodiment can facilitate the on-time arrival of the aircraft. Generally, the operations of the system and method, that is, the determination of the recommended airspeed to be output to the auto-throttle, is executed repeatedly during a flight, such as every five minutes while the aircraft is at a cruising altitude and the auto-pilot is activated, with the inputs typically varying from one iteration to the next as the various parameters that define or otherwise impact the flight vary.

Typically, the inputs which are received and modeled by the computing device include, but are not limited to, the current time, the destination airport, the scheduled arrival time, the optimal aircraft airspeed (i.e., the speed at which fuel efficiency is maximized), the minimum aircraft airspeed, the maximum aircraft airspeed, the current distance to the destination airport, the current time to the scheduled arrival time, and the current wind conditions (i.e., amount of headwind or tailwind). These inputs may be received from various instruments on the aircraft, from the flight management computer, or may be manually input by the flight crew. Most of the inputs will frequently or constantly change during flight. For example, the wind speed is an example of an input value that will most likely change and thus likely cause a change in the recommended airspeed. Some of the inputs might, but would typically not, change during flight, such as the destination airport and the scheduled arrival time. Even if one of the inputs that infrequently changes does change, the system and method of embodiments of the present invention can adjust the recommended airspeed during the flight. For example, if the destination airport encounters a local scheduling problem, the airport could reschedule aircraft landing slots and transmit the new schedules to the incoming aircraft. The system and method of one embodiment could then enable incoming aircraft to alter their airspeed and thus their arrival time, thereby avoiding unnecessary congestion and fuel consumption.

As explained below, the system and method of one embodiment will apply different sets of rules that are created to address different, and at least sometimes potentially competing, objectives. For example, the objectives may include: (1) a first objective to deliver the aircraft to its destination within a predefined arrival window, regardless of the length of the flight; (2) a second objective to maximize fuel efficiency of the aircraft during the flight; and (3) a third objective to ensure that any airspeed changes, such as those required to ensure on-time arrival, are as imperceptible to the passengers as possible. The system and method of one embodiment is designed to manage the reconciliation of these perspectives to produce the recommended airspeed adjustment. In this regard, the system and method generally determines the airspeeds that would be recommended if each objective were considered individually and then compromises between the plurality of recommended airspeeds based upon the current flight conditions. Because of the superb scalability and low coupling, high cohesion characteristics of its architecture, the system and method of at least some embodiments of the present invention may be extended to consider any of a number of objectives in addition to or instead of the three objectives mentioned herein.

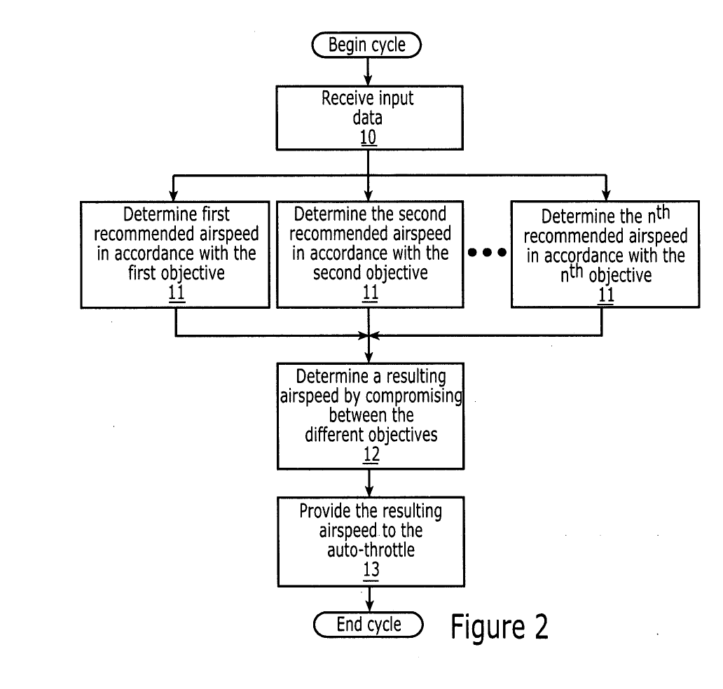

FIG. 2 is a high-level flowchart of the operation of a system and method for facilitating on-time arrival of an aircraft, according to one embodiment of the present invention. Although the operations illustrated in FIG. 2 could be continuously executed, the operations would typically be executed repeatedly during the flight of an aircraft, such as every one minute or every five minutes. As shown in block 10, the system receives input data associated with the operation of an aircraft. As discussed above, these inputs typically include, but are not limited to, such criteria as the current distance to the destination airport, the current time, the scheduled arrival time, the time remaining to arrive on time, the optimal aircraft airspeed, the minimum recommended aircraft airspeed, the maximum recommended aircraft airspeed and the current wind conditions.

These inputs typically represent either raw data values or values derived from the raw data values. The current time, the current distance to the destination airport, and the time remaining to arrive on time will typically change every time the operations represented by FIG. 1 are executed. The current wind conditions may also change frequently during a flight. The destination airport and the scheduled arrival time may change during flight, although will typically not change during flight. The optimal aircraft airspeed, the minimum aircraft airspeed, and the maximum aircraft airspeed will likely be predefined to conform to the characteristics of the particular aircraft.

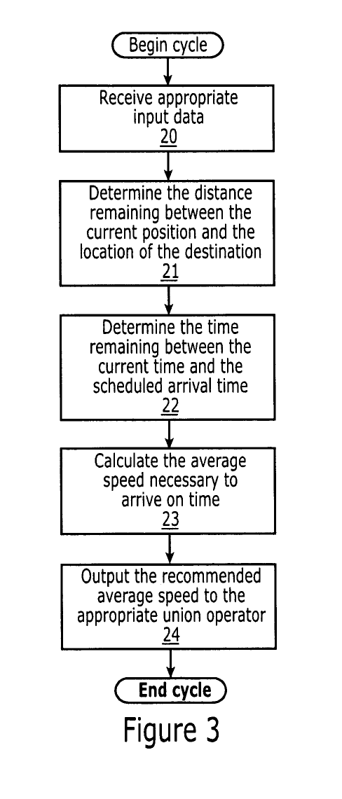

After receiving the input data, the system and method of the embodiment of FIG. 2 will individually and separately analyze the input data in accordance with the rule sets and algorithms for each of the different objectives without regard for and therefore independent of the point of view of the other objectives. As a result of this separate analysis of the input data in accordance with each objective, the system and method determines a recommended airspeed based upon each respective objective, without taking the other objectives into consideration. See blocks 11 of FIG. 2. Although the system and method may work with any number of objectives as illustrated by the reference to n objectives in FIG. 2, an embodiment of the present invention will be described below which has three different objectives. The operations associated with the individual consideration of each of these three objectives are illustrated in FIGS. 3, 4, and 5, respectively, and discussed in greater detail below.

Once the plurality of recommended airspeeds have been determined, the system and method determines a final recommended airspeed (termed a “resulting airspeed”), typically by applying appropriate weights and appropriate union operations to the plurality of recommended airspeeds that are provided by the separate analysis of the different objectives. See block 12 of FIG. 2. The resulting airspeed would typically be output to the auto-throttle of the aircraft. See block 13.

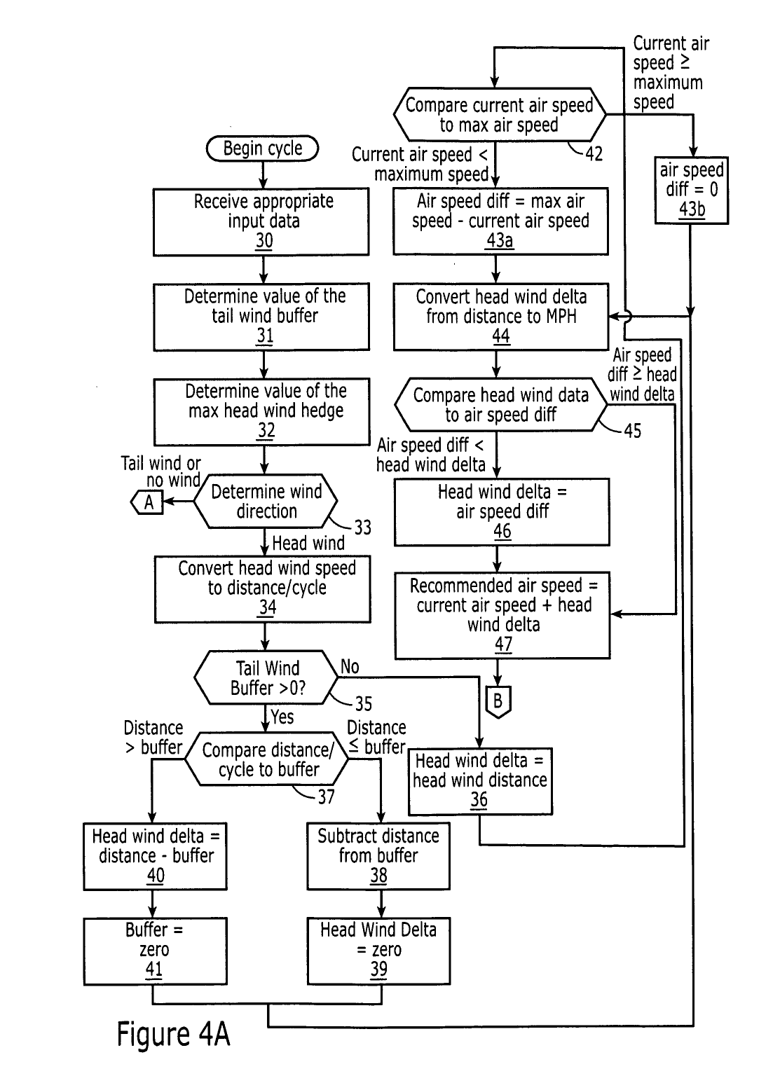

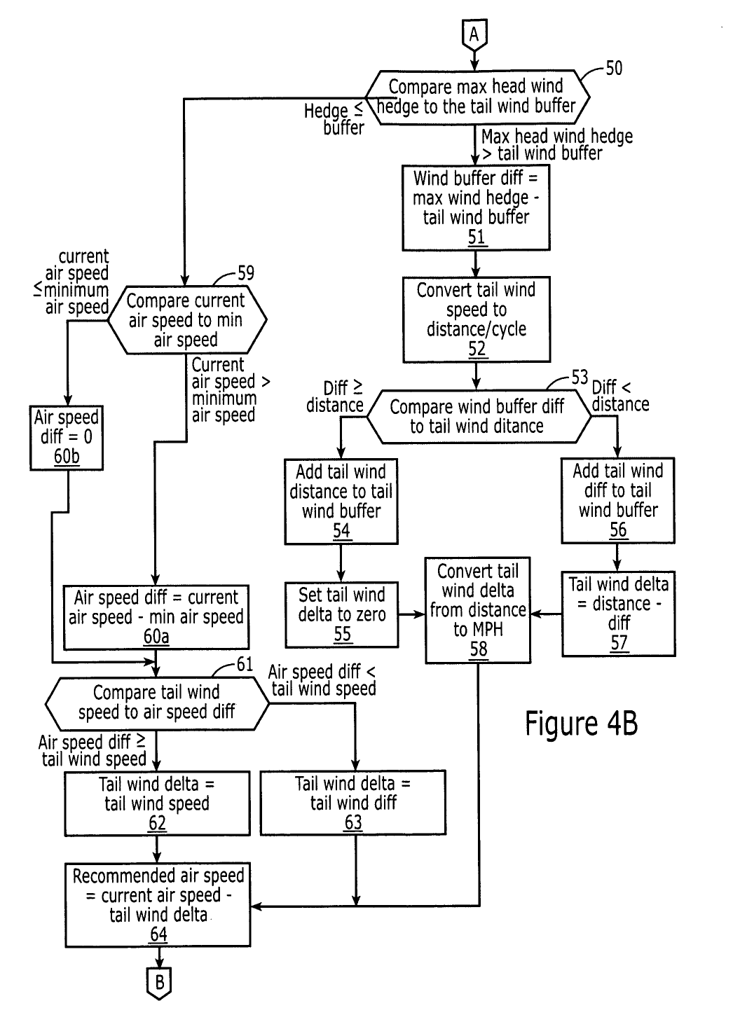

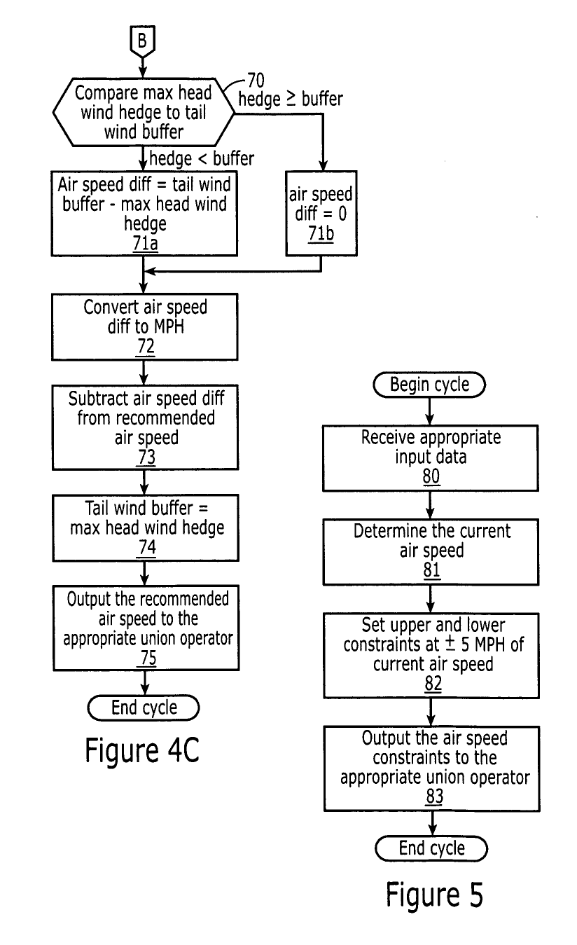

By way of example, but not of limitation, the operations of the method and system of one embodiment will be described in conjunction with the determination of the recommended airspeeds based upon the individual consideration of thee different objectives. In this regard, FIG. 3 depicts the operations associated with the determination of the recommended airspeed based upon an objective of delivering the aircraft to its destination within a predefined arrival window. Similarly, FIGS. 4 and 5 depict the operations associated with the determination of the recommended airspeed based upon an objective of maximizing fuel efficiency of the aircraft during the flight and an objective of ensuring that any airspeed changes are as imperceptible to the passengers as possible, respectively.

In conjunction with the objective of delivering the aircraft to its destination within a predefined arrival window, the embodiment of the system and method represented by FIG. 3 and, more particularly, the underlying rule set and accompanying algorithm is focused on only one factor, that is, covering the distance between the aircraft's current location and the airport in time to achieve an on-time arrival, regardless of the length of the flight. Since the manifestation of the objective shown in FIG. 3 determines an average speed over the remaining distance, any increase or decrease in the recommended airspeed is frequently small and well within the aircraft's ability to achieve.

For illustrative purposes, the embodiment depicted by FIG. 3 and described below is only predicated upon how far the aircraft has to travel from the aircraft's current location to its destination. Using the time interval remaining until the scheduled arrival time, together with the distance the aircraft must travel, the embodiment of the system and method depicted by FIG. 3 will calculate the average speed the aircraft has to travel in order to land on time or, more generally, within a predefined window of time. However, in other embodiments, additional criteria may be considered in conjunction with the objective of delivering the aircraft to its destination within a predefined arrival window with the system and method of these other embodiments utilizing the scalable rule sets mentioned above to achieve this goal. For example, a change in the arrival time or a change in the destination airport may be provided as an input and would need to be considered in calculating the average speed of the aircraft. Additionally, as the speed of an aircraft during landing operations is typically less than its cruising speed. As such, the recommended speed may be set to a value greater than the average speed in some embodiments in anticipation of the slow down during landing; much in the same way that the headwind hedge that is described hereinafter encourages the aircraft to be flown faster earlier in the flight to accommodate any subsequent slow downs.

Referring to FIG. 3 to illustrate the operations described above, the distance to the destination is typically determined. See block 21. The amount of time until the scheduled arrival time is also typically determined. See block 22. The average speed that would be required to travel the distance to the destination in the time remaining is then determined, such as by dividing the distance to the destination by the amount of time until the scheduled arrival time. See block 23. This calculated average speed (or, in another embodiment, a speed greater than the average speed by an amount that is determined to offset the anticipated slow down that will occur during and immediately prior to landing) is provided to the appropriate union operator as the recommended adjustment to the auto-throttle from the viewpoint of satisfying the objective of delivering the aircraft to its destination within a predefined arrival window. See block 24 of FIG. 3 and block 12 of FIG. 2.

In one embodiment of the present invention, another objective is to maximize the fuel efficiency of the aircraft during the flight as shown in FIGS. 4A, 4B and 4C. Notably, this second objective is not directly concerned the first objective, that is, delivery of the aircraft to the destination within a predefined arrival window. As such, the recommended airspeed that is generated as a result of consideration of the second airspeed will effectively function to a certain extent as a constraint on the recommended airspeed determined from consideration of the first objective.

For purposes of an illustrative, but not a limiting, example, the embodiment of the system and method illustrated in FIGS. 4A-4C attempts to optimize one factor, fuel efficiency, by using two accumulators, a headwind hedge and a tailwind buffer, to take advantage of any tailwinds occurring early in the flight to provide a hedge against possible headwinds occurring later in the flight.

The tailwind buffer is a measure of how much extra distance the aircraft can travel while maintaining the same airspeed because of encountered tailwinds during the flight beyond the distance the aircraft would have traveled if the airspeed had been reduced by an amount sufficient to be offset by the tailwinds when the tailwinds were encountered. If the aircraft encounters a tailwind, instead of slowing down as the recommended airspeed generated from consideration of the first objective, i.e., delivery of the aircraft to its destination within a predefined arrival window, would suggest, consideration of this second objective will suggest that the aircraft continue at its current airspeed (and therefore at a higher groundspeed) and accumulate (“save”) the extra distance traveled due to the tailwind and the resulting higher groundspeed in the tailwind buffer. The extra distance traveled as a result of the aircraft maintaining the airspeed when tailwinds were encountered thereby allows the aircraft to slow the airspeed and conserve fuel if headwinds are encountered later in the flight and still land on-time. As such, if a headwind is encountered later, the headwind can be offset by the distance already traveled (accumulated) in the tailwind buffer. The ability to slow the airspeed if headwinds are later encountered conserves fuel. If the aircraft had reduced the airspeed when the tailwinds were encountered and thus had not accumulated the extra distance in the tailwind buffer, then if the aircraft encounters headwinds later in the flight, the pilot would have to choose between increasing the airspeed to counteract the headwinds, thereby reducing fuel efficiency, or maintaining the current airspeed and possibly arriving late. This buffer asset is especially important since fuel consumption is progressively greater for an aircraft traveling above its optimum airspeed than for the same aircraft traveling below its optimum airspeed.

The headwind hedge is a constraint on the amount of tailwind the aircraft can accumulate in the tailwind buffer to offset potential headwinds and still arrive on time.

At the start of the flight, if the aircraft could have left far enough ahead of schedule that it could fly all the way to its destination at its minimum airspeed, then the distance that the aircraft could have traveled in that same time at the optimal airspeed may be termed the maximum headwind hedge. As the flight progresses, this headwind hedge gradually shrinks until it reaches zero when the aircraft lands, as the same process is repeated but only over the remaining distance to the destination. The accumulation in the tailwind buffer indicates that the plane is actually closer to its destination than it would be if it had slowed to counteract the tailwind. If sufficient headwinds are not encountered to use up the extra distance in the tailwind buffer, the plane will have to slow down in order to use up the extra distance or it will arrive early. However, the plane can only slow down so much before reaching its minimum cruising speed. The headwind hedge keeps a running tab of how much tailwind can be saved in the tailwind buffer that can be used up by traveling at minimum cruising speed if no additional headwind is encountered. If the tailwind buffer exceeds the maximum headwind hedge, the aircraft will spend down the tailwind buffer by slowing its airspeed until it equals the headwind hedge so that it will not arrive early at its destination.

There is a limit to how much tailwind is preferably accumulated in the tailwind buffer. Therefore, the logic illustrated in FIGS. 4A-4C will typically compare the tailwind buffer to the headwind hedge, to make sure that the tailwind buffer is lower than, or at least no greater than, the headwind hedge.

If the tailwind buffer is lower than the headwind hedge, the aircraft can continue to accumulate the tailwind in its buffer. When the tailwind buffer is no longer lower than the headwind hedge, the consideration of the objective set forth in FIGS. 4A-4C will suggest expending the excess in the tailwind buffer by reducing the airspeed until the two accumulators are equal. If the aircraft encounters a headwind and there is an accumulation in the tailwind buffer, the objective set forth in FIGS. 4A-4C will typically suggest that the buffer be reduced instead of increasing the airspeed to counter the headwind. If the aircraft encounters a headwind and there is no accumulation in the tailwind buffer, the consideration of the objective set forth in FIGS. 4A-4C will typically suggest increasing the airspeed to counter the headwind.

Referring now to FIGS. 4A-4C to illustrate the operations described above, the current value of the headwind hedge and tailwind buffer are determined, as discussed above and as shown in blocks 31 and 32. As noted in FIG. 4A, this value of the headwind hedge is also termed the maximum headwind hedge. Next, the direction of the wind is determined in block 33. If the wind is a tailwind, operation of this embodiment of the system and method proceeds to block 50 of FIG. 4B. If the wind is a headwind, then the on-time arrival scheduler will typically convert the headwind speed to the distance (termed the headwind distance) that would be traveled at that speed during the duration of the temporal cycle (block 34). In this regard, the temporal cycle is defined as the time period at which the operations are repeated. Thus, for example, the system and method of the present invention may repeat the operations once every one minute for the duration of the flight or once every five minutes for the duration of the flight with the temporal cycle being one minute and five minutes, respectively.

Then the on-time arrival scheduler will typically determine whether there is any unspent balance in the tailwind buffer (block 35). If there is nothing in the tailwind buffer, then a headwind delta will be set to the value of the head wind distance (block 36) and operations will typically proceed to block 42.

If there is an unspent balance in the buffer, there is a need to determine whether this amount is sufficient to cover the distance potentially lost by bucking the head wind during this cycle (block 37). If the headwind distance is determined to be less than or equal to the distance in the tailwind buffer, then the system and method of this embodiment will typically subtract the headwind distance from the tailwind buffer (block 38) and set the headwind delta to zero (block 39). By doing so, the aircraft will be able to counter the potential distance lost due to the headwind without increasing its airspeed, thus saving fuel.

If the tailwind buffer does not cover all the distance incurred by the headwind, the system and method of this embodiment will typically subtract the distance in the tailwind buffer from the distance incurred by the headwind, set the headwind delta to the resulting value (block 40), set the tailwind buffer to zero (block 41) and proceed to the operations reflected by block 44.

If the tailwind buffer is empty, the other option of the system and method of this embodiment is to increase the airspeed to counter the headwind. However, the airspeed cannot exceed the maximum airspeed. So, the system and method of this embodiment will typically compare the current airspeed with the maximum airspeed (block 42). If the current airspeed is less than the maximum airspeed, then the difference between these two airspeeds will be calculated (block 43a), while if the current air speed equals or exceeds the maximum airspeed, the airspeed difference will be set to zero (block 43b). In either instance, the headwind delta will be converted from a distance value to a speed or velocity, typically in miles per hour (MPH) (block 44) and compared with this calculated difference (block 45). If the difference is less than the headwind delta, then the headwind delta is set to the value of the difference (block 46). Otherwise, the value of the headwind delta will typically remain unchanged. In either case, the recommended airspeed will be typically set to the value of the current airspeed plus the headwind delta (block 47) and the logic flow will proceed to block 70 of FIG. 4C.

As mentioned above, the embodiment of FIGS. 4A-4C has generally been only concerned with headwind speed and its relation to the tailwind buffer. In other embodiments, however, the system and method may take additional considerations into account with their inclusion being governed by additional rules.

For example, if the balance maintained by the tailwind buffer is insufficient to offset the current headwind, the system and method of another embodiment may consider the amount of fuel on board to ensure that the aircraft can reach its destination without refueling along the way. If the present fuel capacity cannot sustain an increase in airspeed sufficient to completely offset the headwind and remain aloft for the remainder of the flight, then the fuel capacity may also be taken into account in maximizing the fuel efficiency of the aircraft during the flight in order to determine how much airspeed increase can be recommended.

Additionally, the system and method of one embodiment may also consider the weather conditions that the aircraft might encounter for the remainder of the flight. These conditions might be obtainable through an electronic feed from the weather service or from the pilot. If there was not a sufficient balance in the tailwind buffer to offset the current headwind, weather conditions during the remainder of the flight might indicate the likelihood of a yet-to-be encountered tailwind that could offset the current headwind. The ability to consider upcoming weather conditions would also allow the system and method to determine the duration of the current headwinds.

As such, the system and method of one embodiment may also consider additional inputs, such as the current headwind intensity, how long the current headwind is likely to last as the flight progresses, the status of the tailwind buffer, the status of the on-board fuel supply, the intensity of yet-to-be encountered headwinds, the duration of these headwinds, the intensity of yet-to-be encountered tailwinds and the likely duration of these tailwinds. The system and method of this embodiment would require eight antecedent criteria to determine the recommended airspeed. As described in more detail below, if each of these antecedent criteria were segmented into just five categories and if the system and method were to use the traditional rule configuration as outlined above, then the total number of rules in the rule set for the headwind objective could contain as many as 5⁸ rules or 390,625 rules. Obviously, the inclusion of more inputs would exacerbate this explosion in the number of rules even more. As described above, however, the alternative rule configuration used by the system and method of embodiments in this invention would yield a maximum of 5 times 8 or 40 rules—a significant advantage in comprehensibility, maintainability and performance. In fact, the use of this alternative rule configuration to support a more realistic embodiment makes the use of rules more plausible not only in consideration of the objective relating to the maximization of fuel efficiency, but also in consideration of the other objectives.

Returning now to FIGS. 4A-4C, if the wind is determined to be a tailwind, then the system and method of this embodiment will typically compare the maximum headwind hedge with the tailwind buffer to see if some or all of the tailwind can be added to the tailwind buffer (block 50). If the maximum headwind hedge determined in block 32 is greater than the tailwind buffer, then the difference between these two is typically calculated (block 51). The tailwind speed is then converted to the extra distance the plane would travel (if maintained at the same airspeed) during the cycle with the assistance of the tailwind (block 52) and that value (termed the tailwind distance) is compared with the difference (termed the tailwind difference) between the maximum headwind hedge and the tailwind buffer (block 53). If the tailwind difference is greater than or equal to the tailwind distance, then the tailwind distance is added to the tailwind buffer (block 54), and the tailwind delta is set to zero (block 55). However, if the tailwind difference is less than the tailwind distance, then the tailwind difference is added to the tailwind buffer (block 56), the tailwind delta is set to the tailwind distance minus the tailwind difference (block 57), the tailwind delta is converted from a distance value to a speed (MPH) value (block 58) and operations typically proceed to block 64.

If the maximum headwind hedge is not greater than the tailwind buffer, the only other option is for the aircraft to slow down in order to arrive on time. In order to determine the maximum amount the plane can slow down, the system and method of this embodiment typically compares the current airspeed with the minimum airspeed (block 59). If the current airspeed is greater than the minimum airspeed, then an airspeed difference is typically calculated as the value of the current airspeed minus the value of the minimum airspeed (block 60a). In contrast, if the current air speed is less than or equals the minimum air speed, the air speed difference will be set to zero (block 60b).

In either instance, the air speed difference is then typically compared with the speed of the tailwind (block 61). If the airspeed difference is greater than or equal to the tailwind speed, then the tailwind delta is set to the tailwind speed (block 62). Otherwise, the tailwind delta is set to the tailwind difference (block 63). In either event, the tailwind delta is subtracted from the current airspeed to yield the recommended airspeed (block 64), and operations will typically proceed to block 70.

If the value in the tailwind buffer exceeds the value in the maximum headwind hedge, then the system and method of this embodiment will typically recommend that the aircraft use up some of the distance saved in the tailwind buffer while it is still traveling at a rate of speed in excess of its minimum speed. Otherwise, the time will come near the end of the flight when the aircraft will not be able to slow down enough to land on time because it will already be traveling at its minimum speed. When the system and method of the embodiment of FIGS. 4A-4C has finished considering the effect of either a headwind or a tailwind on its recommendation, the relationship between the maximum headwind hedge and the tailwind buffer will be examined (block 70) and a recommended airspeed will be determined.

If the headwind hedge is less than the tailwind buffer, then an airspeed difference will typically be calculated as the value of the tailwind buffer minus the value of the headwind hedge (block 71a). Alternatively, if the maximum headwind hedge equals or exceeds the tailwind buffer, the airspeed difference is set to zero (block 71b). The airspeed difference will be converted from a distance value to a speed (MPH) value (block 72) and then subtracted from the recommended airspeed (block 73). The tailwind buffer can now be set to the value of the headwind hedge (block 74) and the recommended airspeed generated by the system and method of the embodiment of FIGS. 4A-4C can typically be output to the appropriate union operator as shown in block 75 of FIG. 4C and block 12 of FIG. 2.

The third objective that is taken into account by the system and method of the illustrated embodiment is depicted by FIG. 5 and is designed to ensure that any airspeed changes recommended following consideration of the other objectives are as imperceptible to the passengers as possible. For the purposes of illustration in this embodiment, this third objective will be modeled as a simple set of upper and lower constraints. As an example for this embodiment, the system and method that implements this third objective will recommend that the airspeed during any given cycle be increased or decreased by no more than five miles per hour. In other embodiments, these constraints may be more complex and may be governed by the alternative scalable rule configuration mentioned above.

During a given cycle, the system and method of this embodiment will typically receive relevant data upon which to base its decisions (block 80). For example, the aircraft's current airspeed is generally determined (block 81), an upper and lower constraint airspeed is generated by adding and subtracting the upper and lower constraints, e.g., +/−5 mph, to the current airspeed (block 82), and the upper and lower constraint airspeeds are output to an appropriate union operator as shown in block 83 of FIG. 5 and block 12 of FIG. 2.

Notably, the consideration of each of the objectives provided by the system and method of the illustrated embodiment generates recommended airspeeds that are independent of one another since the underlying objectives are different. Moreover, while the consideration of three different objectives was described above by way of example, the system and method could determine a recommended airspeed based upon any number of different objectives if so desired.

The recommended airspeeds that are determined from consideration of each respective objective are then considered and a compromise is made therebetween based upon the current flight conditions so as to generate a resulting airspeed that may be input to the auto-throttle of the aircraft. As described above, one embodiment of the methodology by which the system and method of one embodiment considers and reaches a compromise between the various recommended airspeeds is depicted in FIG. 2 which models the multi-objective control perspectives outlined above. In this regard, the output obtained from consideration of the first objective illustrated in FIG. 3 can be thought of as (A implies R) wherein the antecedent variable A is the delivery of the aircraft to the destination within a predefined window of time, i.e., an acceptable arrival window, and the consequent R is the recommended airspeed generated from a consideration of the first objective alone. Similarly, the output obtained from consideration of the second objective illustrated in FIGS. 4A-4C can be thought of as (B implies R) wherein the antecedent variable B is the maximization of fuel efficiency and the consequent R is again the recommended airspeed generated from a consideration of the second objective alone. Finally, the output obtained from consideration of the third objective illustrated in FIG. 5 can be thought of as (C implies R) wherein the antecedent variable C is the minimization of the perception of any airspeed changes by the passengers and the consequent R is still the recommended airspeed, or recommended range of airspeeds in this instance, generated from a consideration of the third objective alone. The union of these three implication relationships is then determined by the system and method as shown in block 12 of FIG. 5.

In this regard, the union operator can be modeled algorithmically or stochastically by the system designer as simply as a summation aggregation or in a manner as sophisticated as desired by the designer to faithfully represent the relationships between the functioning implication relations of the architectural configuration. In terms of a model, the operation depicted by block 12 of FIG. 5 could be thought of as a meeting between three agents with different perspectives on the task at hand (one arriving from each different block 11) and another agent who must decide the best recommendation to pass along to the autopilot (block 13) based on the three recommendations.

The system and method of one embodiment may determine the resulting airspeed by compromising between the recommended airspeeds generated in response to consideration of each objective individually. In this regard, the system and method may compromise between the different recommended airspeeds based upon the current flight conditions so that the resulting airspeed is effectively tailored to the current situation. For example, the recommended airspeeds that are suggested by consideration of the second and third objectives as shown in FIGS. 4 and 5 are constraints upon the recommended airspeed generated in response to the consideration of the first objective as shown in FIG. 3. As such, the system and method of one embodiment may compromise between the different recommended airspeeds by passing along the smallest recommended airspeed change, e.g., the smallest from among the three different recommended airspeeds, as the resulting airspeed to the autopilot. In this regard, at least some of the recommended airspeeds are based upon the current flight conditions such that the resulting airspeed that is generated by the system and method of this embodiment is also based upon the current flight conditions.

One notable aspect of the system and method of the present invention is the time at which the resulting airspeed is formulated. For the traditional structure [(A intersection B) implies R], it is the intersection of A and B that has an implication relation with R. This intersection has to be calculated before the implication relation can be established with R. If the intersection is represented by “I”, this structure can be reduced to [I then R], and the resulting representation holds no matter how many antecedent criteria are present. Keeping with the model of consultant agents, this intersection format would have the agents meeting to arrive at a compromise recommendation that they felt might be appropriate for use by the higher-level agent. They would not necessarily know what recommendation would best fit the needs of the higher-level agent because they would not be privy to the implication relation until after they had formulated their recommendation.

For the alternative architecture [(A implies R) union (B implies R)] employed by embodiments of the present invention, the resulting airspeed is the result of the union of the implication relations. Each antecedent agent brings its recommendation to the upper-level agent who can then decide which recommendation or which combination of recommendations best suits the current situation. Since the union operators perform their activity in light of the implication relations, the upper-level agent can tailor the resulting airspeed to the current flight conditions rather than rely on the single recommendation from the traditional architecture. Delaying the decision in this manner also enables the higher-level agent to more easily resolve conflicting or even contradicting recommendations because of the loosely coupled characteristics of the union operator. For more information on the rule configuration employed by embodiments of the present invention, see The Combs Method for Rapid Inference, William E. Combs (1997), the contents of which are hereby incorporated by reference in its entirety.

Although not necessary, the recommended airspeeds generated by consideration of each individual objective can be differently weighted to emphasize the recommendation of one objective more than the others in the context of determining the resulting airspeed from the plurality of recommended airspeeds. Delaying the decision also allows the higher-level agent to decide how to weight the recommendations based on the current situation. For example, the constraint to modify the airspeed by no more than five miles per hour per cycle might be considered either as a hard or soft constraint based on whether the aircraft is near the end of the flight when increased speed adjustments might be more generally tolerated by the passengers. As such, the constraint limiting airspeed modifications to five miles per hour per cycle could be weighted more greatly during an intermediate portion of the flight than near the end of the flight. By weighting a recommendation more greatly, the resulting airspeed will be influenced more greatly by the recommendation with the larger weight than those recommendations that are weighted more lightly.

The system and method of embodiments of the present invention may afford a number of advantages. For example, instead of relying on the traditional rule configuration of the form [(A intersection B) implies R], the rule configuration utilized by the system and method of embodiments of this invention, that is, [(A implies R) union (B implies R)] or more informally: [(A then R) or (B then R)], is fully scalable. In the traditional configuration, it is the intersection of the antecedent variables that has an implication relation with the consequent rather than the antecedent variables themselves. As such, a change in the condition of any antecedent criteria potentially generates a different rule even if the conditions of the other variables remain the same. On the other hand, the rule configuration employed by embodiments of the system and method of the present invention allows each antecedent variable to have its own unique implication relation with the consequent. Thus, changes to one antecedent condition will not impact the implication relations of any of the other antecedents, yielding an additive rather than an exponential increase in the number of potential rules generated as the number of antecedent variables increases and thereby resulting in a scalable architecture.

For example, if the rule set employed by the system and method of an embodiment of the present invention relied on only one antecedent criterium selected from the group consisting of calibrated values for airspeed, ground speed, the distance to destination and the time to scheduled arrival, then it would likely contain five rules with one rule for each antecedent condition—the same number of rules as utilized by a conventional rule set. But if a second antecedent variable were added, then the rule set employed by the system and method of an embodiment of the present invention would only contain up to ten rules since the original antecedent conditions would not be affected by the five additional conditions of the second antecedent. Thus, the total number of potential rules would be the accumulation of the conditions that each antecedent would have through its implication relation with the consequent, thereby resulting in an additive increase. Including a third criteria would increase the potential rule set to fifteen rules. And adding a fourth and fifth antecedent would increase the potential rule set to twenty and twenty-five rules, respectively. Since the number of rules utilized by a conventional rule set expands exponentially based upon the number of antecedents, the system and method of the present invention will work with a dramatically smaller number of rules as the number of antecedents increases.

Because the rule configuration is fully scalable, there may not be a need to prune any rules from the system and method for performance reasons. As a result, this methodology avoids gaps in the rule space, eliminating anomalous system conditions as well as the need for additional fencing techniques.

Since each antecedent variable has its own implication relation with the consequent, such as the resulting airspeed to provide to the auto-throttle, it may also be much easier for the system designer to more fully comprehend the dynamics of that relationship and to devise rules based on that understanding. So, it may be more likely that the designer will be able to faithfully capture the system's behavioral characteristics no matter how many antecedents are involved.

The rule configuration employed by embodiments of the present invention can also yield more system robustness. For example, since each antecedent has its own implication relation with the consequent, cohesion is high. And, since changes to the conditions of one antecedent do not impact the implication relations of the other antecedents, coupling is low. The combination of higher cohesion and lower coupling leads to improved system robustness.

According to embodiments of the present invention, the more tolerant characteristics of the union operator also allow the resulting control systems and methods to be more fault tolerant. If a sensor malfunctions or fails that is feeding one of the antecedents producing a value at or near zero, that value will have a minimal impact on the values of the remaining antecedents because they are loosely coupled through union. Thus, a system based on this methodology tends to degrade gracefully in the face of any sensor failure.

As noted above, the system and method of facilitating on-time arrival of an aircraft may be embodied by a computer program product. The computer program product includes a computer-readable storage medium, such as the non-volatile storage medium, and computer-readable program code portions, such as a series of computer instructions, embodied in the computer-readable storage medium. Typically, the computer program is stored by a memory device and executed by an associated processor, such as the flight management computer or the like.

In this regard, FIGS. 2-5 are block diagrams and flowcharts of methods and program products according to the invention. It will be understood that each block or step of the block diagram and flowchart, and combinations of blocks in the block diagram and flowchart, can be implemented by computer program instructions. These computer program instructions may be loaded onto a computer or other programmable apparatus to produce a machine, such that the instructions which execute on the computer or other programmable apparatus create means for implementing the functions specified in the block diagram or flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram or flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram or flowchart block(s) or step(s).

Accordingly, blocks or steps of the block diagram or flowchart support combinations of means for performing the specified functions, combinations of steps for performing the specified functions and program instruction means for performing the specified functions. It will also be understood that each block or step of the block diagram or flowchart, and combinations of blocks or steps in the block diagram or flowchart, can be implemented by special purpose hardware-based computer systems which perform the specified functions or steps, or combinations of special purpose hardware and computer instructions.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A method of controlling the airspeed of an aircraft, the method comprising:
determining a first recommended airspeed based on a first objective;
determining a second recommended airspeed, independent of the first recommended airspeed, based on a second objective different from the first objective; and
determining a resulting airspeed from the first and second recommended airspeeds based on a compromise between the first and second objectives in view of the current flight conditions.

2. The method of claim 1, wherein one of the first and second objectives is delivery of the aircraft to the destination within a predefined arrival window.

3. The method of claim 1, wherein one of the first and second objectives is maximization of fuel efficiency of the aircraft.

4. The method of claim 1, wherein one of the first and second objectives is reduction in passengers' perceptibility of airspeed changes of the aircraft.

5. The method of claim 1, wherein determining a resulting airspeed further comprises weighting each recommended airspeed.

6. The method of claim 1, further comprising applying the resulting recommended airspeed to an auto-throttle of the aircraft.

7. A method of controlling the airspeed of an aircraft, the method comprising:
determining a plurality of recommended airspeeds, each one of the plurality of recommended airspeeds being determined based on at least one objective different from the objectives of the rest of the airspeeds, and
determining a resulting airspeed from the plurality of recommended airspeeds based on a compromise between the plurality of objectives in view of the current flight conditions.

8. The method of claim 7, wherein at least one of the objectives is delivery of the aircraft to the destination within a predefined arrival window.

9. The method of claim 7, wherein at least one of the objectives is maximization of fuel efficiency of the aircraft.

10. The method of claim 7, wherein at least one of the objectives is reduction in passengers' perceptibility of airspeed changes of the aircraft.

11. The method of claim 7, wherein determining a resulting airspeed further comprises weighting each recommended airspeed.

12. The method of claim 7, further comprising applying the resulting recommended airspeed to an auto-throttle of the aircraft.

13. An aircraft with a system for controlling the airspeed of the aircraft, the system comprising:
a computing device capable of:
determining a first recommended airspeed based on a first objective;
separately determining a second recommended airspeed , independent of the first recommended airspeed, based on a second objective different from the first objective; and
determining a resulting airspeed from the first and second recommended airspeeds based on a compromise between the first and second objectives in view of the current flight conditions.

14. The aircraft of claim 13, wherein one of the first and second objectives is delivery of the aircraft to the destination within a predefined arrival window.

15. The aircraft of claim 13, wherein one of the first and second objectives is maximization of fuel efficiency of the aircraft.

16. The aircraft of claim 13, wherein one of the first and second objectives is reduction in passengers' perceptibility of airspeed changes of the aircraft.

17. The aircraft of claim 13, wherein determining a resulting airspeed further comprises weighting each recommended airspeed.

18. The aircraft of claim 13, further comprising an auto-throttle, and wherein the computing device is further capable of applying the resulting recommended airspeed to the auto-throttle.

19. An aircraft with a system for controlling the airspeed of the aircraft, the system comprising:
a computing device capable of:
determining a plurality of recommended airspeeds, each one of the plurality of recommended airspeeds being determined based on at least one objective different from the objectives of the rest of the airspeeds, and
determining a resulting airspeed from the plurality of recommended airspeeds based on a compromise between the plurality of objectives in view of the current flight conditions.

20. The aircraft of claim 19, wherein at least one of the objectives is delivery of the aircraft to the destination within a predefined arrival window.

21. The aircraft of claim 19, wherein at least one of the objectives is maximization of fuel efficiency of the aircraft.

22. The aircraft of claim 19, wherein at least one of the objectives is reduction in passengers' perceptibility of airspeed changes of the aircraft.

23. The aircraft of claim 19, wherein determining a resulting airspeed further comprises weighting each recommended airspeed.

24. The aircraft of claim 19, further comprising an auto-throttle, and wherein the computing device is further capable of applying the resulting recommended airspeed to the auto-throttle.
